(19) United States
(12) Patent Application Publication
(10) Pub. No.: US 2025/0390421 A1
(43) Pub. Date: Dec. 25, 2025

(54) FRAMEWORK FOR TEMPLATE-BASED TEST DATA

(71) Applicant: SAP SE, Walldorf (DE)

(72) Inventors: Prashant TELKAR, Bangalore (IN); Shwetha Kamath B M, Bangalore (IN); Vishwas AGRAWAL, Mandla (IN); Manan DEY, Guwahati (IN); Meldon Malcolm DCUNHA, Vasai (IN)

(21) Appl. No.: 18/748,923

(22) Filed: Jun. 20, 2024

(51) Int. Cl. G06F 11/36

(52) U.S. Cl. CPC G06F 11/3684

(57) ABSTRACT

According to some embodiments, systems and methods are provided including an object data store storing object data for each object, the object data including one or more properties; a template data store storing one or more templates associated with the object data; a memory storing processor-executable program code; and a processing unit to execute the processor-executable program code to cause the system to: retrieve information from the object data store for a first object, including available properties for the first object; define the first object with at least one retrieved available property, the defined first object is a template candidate; generate simulated test data with the template candidate; and store the template candidate as a template in the template data store. Numerous other aspects are provided.

### BACKGROUND

Many organizations are increasingly dependent on software applications, executed on-premise or in the cloud, that are developed by an application development group to address their needs. These applications may be tested by test tools to verify functional and/or non-functional requirements via test scripts (e.g., test executable code) that test the different aspects of a given application. Functional test data including, but not limited to, sales orders, employee data, partner data, and other suitable transactional data etc. may be needed to execute the tests. A lot of work goes into creating the functional test data, as this data may be created by an expert with knowledge of what needs to be tested, as well as technical knowledge of how to write the programming code to output the test data.

Test data may also be used in demonstrations of the application. For the demonstration, the user would like to execute the demonstration live, but it is often difficult to quickly procure a lot of data from the different aspects of the application. In both the test data for testing an application and test data for a demonstration, a program may need to be written each time test data is needed.

Systems and methods are desired to facilitate the creation of test data.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of an architecture according to some embodiments.

FIG. 2 is a flow diagram of a process according to some embodiments.

FIG. 3A is a diagram illustrating a user interface according to some embodiments.

FIG. 3B is a diagram illustrating a user interface according to some embodiments.

FIG. 4 is a diagram illustrating a user interface according to some embodiments.

FIG. 5A is a diagram illustrating a user interface according to some embodiments.

FIG. 5B is a diagram illustrating a user interface according to some embodiments.

FIG. 6 is a diagram illustrating a user interface according to some embodiments.

FIG. 7 is a flow diagram of a process according to some embodiments.

FIG. 8A is a diagram illustrating a user interface according to some embodiments.

FIG. 8B is a diagram illustrating a user interface according to some embodiments.

FIG. 9 is a diagram illustrating a user interface according to some embodiments.

FIG. 10 is a block diagram of a cloud-based database deployment architecture according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

As described above, test data is used to test (functional and/or non-functional) applications for organizational processes via a test script (test executable code) to ensure the application is operating as expected. As used herein, the terms “automated test script,” “test executable code”, “automate”, “test” “test script” and “automation” may be used interchangeably. The test script may use test data/payload in execution of the test. A payload is the part of the transmitted data or message of a data packet that is the actual intended message (e.g., minus headers attached for transport and minus descriptive meta-data) submitted when a request is made of an application. Before the request is sent to the application, values may be included in the request, and these values yield a particular output for this request. The included values may be test data values that will beget expected output values.

The test data may be categorized into master data and transaction data.

Master data is the fundamental enterprise data in an enterprise and defines the business objects and classifications that describe overall enterprise information. Master data is generally unchanging. A business object is a semantic entity that represents the smallest data unit in a scenario. A business object defines data structures and logic. To define the data structure part of a business object, nodes, elements and associations between the nodes are created. To define the logic, entities such as actions, determinations or validations are created. The business object represents real objects such as orders, customers or articles.

Transaction data encapsulates real-time enterprise activities, is dynamic in nature, and undergoes frequent modifications because of executed enterprise processes (e.g., the initial stock for purple shoes may be 30, and after completion of a purchase transaction the stock is reduced to 29). Transaction data encompasses records pertaining to various enterprise transactions such as sales orders, purchase orders, invoices, deliveries, and production orders, and is specifically tied to enterprise activities or events. Master data refers to the characteristics of an object, whereas transaction data refers to all the transactions that are carried out using that object. The master data and transaction data may be used as test data to test the sales process.

Consider, as a non-exhaustive example, a sales process for a product. In a sales process, a sales order may be issued. The product, the vendor name and/or the customer name are each master data and the sales order may be transaction data. The sales order may include a vendor and/or a customer receiving the item being sold in the sales order, etc., The transaction data may be created using master data, including the name of the vendor and/or name of the customer.

Continuing with the above example, the application under test is for the purchase of shoes, and as part of the test, shoes are purchased as the input and an invoice is created as the output, etc. To adequately test the application, it is desirable to have a lot of data samples and in this example, a lot of different shoes may be purchased by different customers resulting in many invoices as test data for analysis. To create this data for testing, conventionally a programmer with expert knowledge of the process and the technical knowledge to write program code, can write a program to create this data in the system. The program will be run multiple times to create a lot of data for analysis. A challenge with creating the program for test data creation and why experts are generally used is that in the deployment of specific transaction data, certain parameters, such as specific master data, dependent data or localized data are used. Successful deployment of the transaction data is contingent upon the presence of the appropriate master data in the target system, establishing a critical interdependency between master and transaction data, and the need for expert involvement.

To address these problems, a test data template framework or system provides for the creation and execution of a template to create transaction test data. As part of the creation, the template may include essential parameters, including but not limited to, transaction data payload, a target system, business object, OData version, instance name, etc. Each template may be tailored to specific transaction data requirements. With respect to template execution, users may select the appropriate template and deploy it to a designated target system. Pursuant to embodiments, users may modify data within each payload dynamically. In particular, specific field values are alterable, missing properties can be added, fields may be deleted, etc. providing a customizable approach to adapt the template instance to user preferences. The test data template framework provides for the creation of the template based on a selected business object. The business object has been previously defined and loaded into the system with its possible parameters. As such, during template creation, the system calls the definition of the business object and allows this definition to be edited, storing the edited template. The edited template may then be used to generate test data and/or may be further edited to create another template. A benefit provided by embodiments is improved network performance (e.g., by reducing an amount of network message bandwidth required to create test data and/or storage required to create test data and eliminating the need for multiple programs and minimizing processing needs of the system).

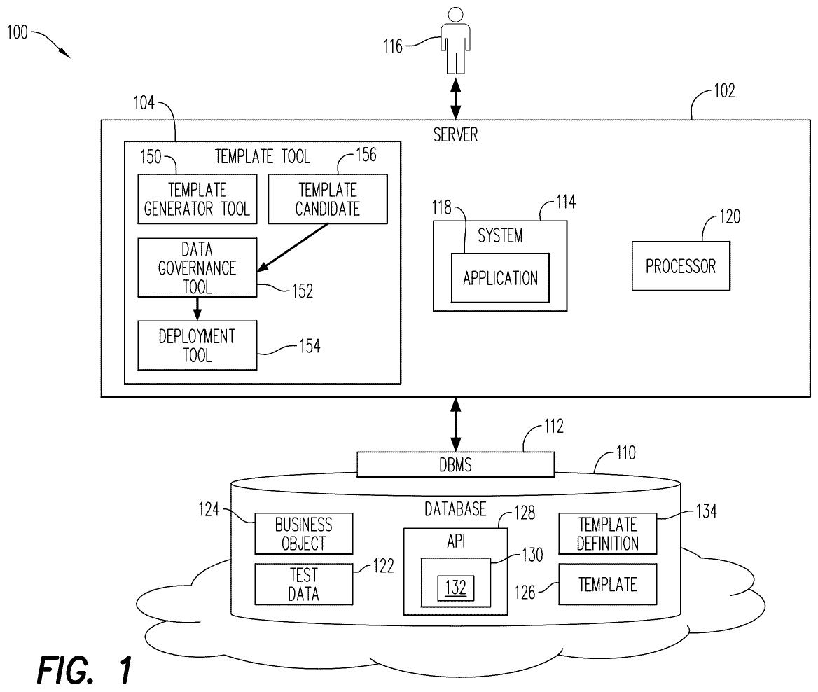

FIG. 1 is a high-level block diagram of a test data template framework or system architecture 100 according to some embodiments. The illustrated elements of system architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of system architecture 100 are implemented by a single computing device, and/or two or more elements of system architecture 100 are co-located. One or more elements of system architecture 100 may be implemented using cloud-based resources, and/or other systems which apportion computing resources elastically according to demand, need, price, and/or any other metric.

System architecture 100 includes a backend server 102 (including an application 118 for a system 114, and processor 120), a template tool 104, a database 110 and a database management system (DBMS) 112.

A client/user 116 may interact with the template tool 104, as described further below. Non-exhaustive examples of users may be administrator/developer, end user, tester, template author, etc. The user 116 may interact with the template tool 104 via a user interface (e.g., graphical user interface (GUI)). The backend server 102 may provide any suitable interfaces through which users 116 may communicate with the template tool 104 or application 118 executing thereon. The user interface may be presented via at least one of a user interface program, a user interface server, another system or any other suitable device executing program code of a software application for presenting user interfaces. Presentation of the user interface may comprise any degree or type of rendering, depending on the type of user interface code generated by the application 118. For example, the backend server 102 may execute a Web Browser request and receive a Web page (e.g., in HTML format) via HTTP, HTTPS and/or WebSocket, from an application 118 to provide the UI, and may render and present the Web page according to known protocols. Alternatively, user interfaces may be presented by executing a standalone executable file (e.g., an .exe file) or code (e.g., a JAVA applet) within a virtual machine.

The backend server 102 may include one or more applications 118. Application 118 may comprise server-side executable program code (e.g., compiled code, scripts, etc.) executing within the backend server 102 to receive queries/requests from users 116 and provide results to users 116 based on the data of database 110, and the output of the template tool 104. As will be described further below, application 118 may comprise web applications which execute to provide desired functionality. User 116 may instruct the system architecture 100, as is known, to create a transaction data template (“template”) or execute the template to generate test data for use by the application under test (e.g., application 118) for a system 114 (e.g., target system).

The template tool 104 may access data in the database 110 and deploy data thereto so that appropriate data, included test data, is provided at runtime. While discussed further below, the database 110 may store test data 122 and other suitable data. Database 110 (and other databases herein) represents any suitable combination of volatile (e.g., Random Access Memory) and non-volatile (e.g., fixed disk) memory used by the system to store the data.

The template tool 104 may include a template generator tool 150, a data governance tool 152, and a deployment tool 154.

The template generator tool 150 may generate a template candidate 156 for a selected business object 124. As described further below, after the template candidate is approved, it is stored in the database 110 as a template 126 and may be executed to generate test data 122. The business object 124 is previously defined with respect to one or more property values. As described above, business object (BO) is a common term to represent real-world units, such as a product, employee or sales order. The business object encompasses both the functionality (in the form of methods) (e.g., creating, updating and deleting data, etc.) and the data (in the form of properties) of this unit. As also used herein the business object (“object”) refers to the metadata defining a semantic entity (e.g., SalesOrder) and a business object instance (“object instance”) refers to the data of an actual Sales Order (e.g., Sales Order 123), which conforms to the structure (e.g., hierarchy) defined by the metadata. A property is an object attached to a parent object that provides additional descriptive information about the parent. The property may be a data element representing the quality or state of an object, for example. An attribute may define a particular property of an object, element or file (e.g., manufacturer number, purchase order quantity unit, product hierarchy, etc.). An attribute may also refer to a specific value for a given instance of that property. A numerical value, for example, may be an attribute of the property Age for the Customer object.

Pursuant to embodiments, the business object 124 may be accessed by an application via an Application Programming Interface (API) 128. Each API 128 may include a plurality of entities 130. Entities 130 are data structures that can be associated as an instance of a transaction. An entity is a version of a business object that can be stored and manipulated by applications. Each entity may include one or more properties 132 that define the entity per the properties described above with respect to the Business Object itself. Herein, the properties 132 of the entity are the same as the properties of the Business Object. As a non-exhaustive example, consider the SalesOrder API for the Sales Order Business Object. The SalesOrder API includes the properties 132: “CustomerPaymentTerms”, “OrganizationDivision”, “PurchaseOrderByCustomer”, and “SoldToParty”. Each property may be a key-value pair and have particular definitions per this API. For example, “CustomerPaymentTerms” indicates how the customer will pay for the product; “OrganizationDivision” indicates the group at the enterprise responsible for this template instance; “PurchaseOrderByCustomer” indicates the party creating the purchase order; and “SoldToParty” indicates the name and/or character identifier of the party purchasing the product. Additionally, the entities for the API may be linked together.

Pursuant to embodiments, the template candidate 156 (and ultimately template 126) created by the template generator tool 150 may include one or more available attributes for the selected Business Object (BO) API and a value for the property. Continuing with the above non-exhaustive example, the SalesOrder API may include four available attributes (CustomerPaymentTerms, OrganizationDivision, PurcahseOrderByCustomer, SoldToParty), and a template may be created for that SalesOrder API with only two of those attributes (e.g., CustomerPaymentTerms and SoldToParty), with the values “0001” and “S10100”, respectively. The template generator tool 150 retrieves the available properties for a given business object and the user creating the template selects properties out of the available properties to include in the template 126. Based on the selections, the template generator tool 150 generates a template candidate 156. The template tool 104 may also be used to convert the test data into a machine-readable (e.g., JSON) format. Other suitable machine-readable formats may be used.

The data governance tool 152 receives the generated template candidate 156 from the template generator tool 150 and may receive designation of the candidate template as approved or rejected per a governing group of users or other suitable user. The generated template candidate 156 may be transmitted to a reviewer, via email or other suitable communication (as part of the data governance tool 152) for final approval before the template candidate 156 may be stored in the database 110 as a template 126. After storage, the template candidate 156 is a template 126 and is available for execution to generate test data.

The deployment tool 154 may run the generated template candidate 156 as a simulation to determine whether the generated template candidate creates the appropriate test data. The test data output from the simulation is also transmitted to the reviewer for review. In a case the test data output by the simulation is appropriate, the template candidate is approved and may be stored in the database as a template. In a case the test data output by the simulation is not appropriate, the template candidate is rejected, the template creator receives a notification of the rejection, and the template author may modify the template candidate and re-submit the template candidate for approval. The deployment tool 154 may also run the stored template to generate test data 122 and then deploy that test data to the target application/system 114, per the template, to test the application/system.

One or more applications 118 executing on backend server 102 may communicate with DBMS 112 using database management interfaces such as, but not limited to, Open Database Connectivity (ODBC) and Java Database Connectivity (JDBC) interfaces. These types of applications 118 may use Structured Query Language (SQL) to manage and query data stored in database 110 (and other databases described here).

DBMS 112 serves requests to store, retrieve and/or modify data of database 110, and also performs administrative and management functions. Such functions may include snapshot and backup management, indexing, optimization, garbage collection, and/or any other database functions that are or become known. DBMS 112 may also provide application logic, such as database procedures and/or calculations, according to some embodiments. This application logic may comprise scripts, functional libraries and/or compiled program code. DBMS 112 may comprise any query-responsive database system that is or becomes known, including but not limited to a structured-query language (i.e., SQL) relational database management system.

Database 110 may store data used by at least one of: applications 118 and the template tool 104. For example, database 110 may store the business objects 124 used to create test data 122 for testing the application 118.

Database 110 (and other databases described herein) may comprise any query-responsive data source or sources that are or become known, including but not limited to a structured-query language (SQL) relational database management system. Database 110 (and other databases described herein) may comprise a relational database, a multi-dimensional database, an extensible Markup Language (XML) document, or any other data storage system storing structured and/or unstructured data. The data of database 110 (and other databases described herein) may be distributed among several relational databases, dimensional databases, and/or other data sources. Embodiments are not limited to any number or types of data sources.

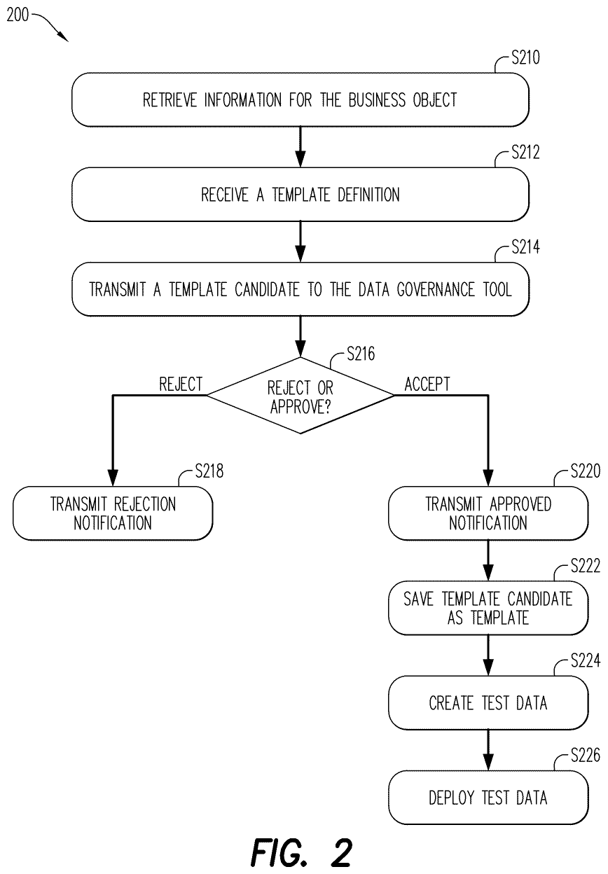

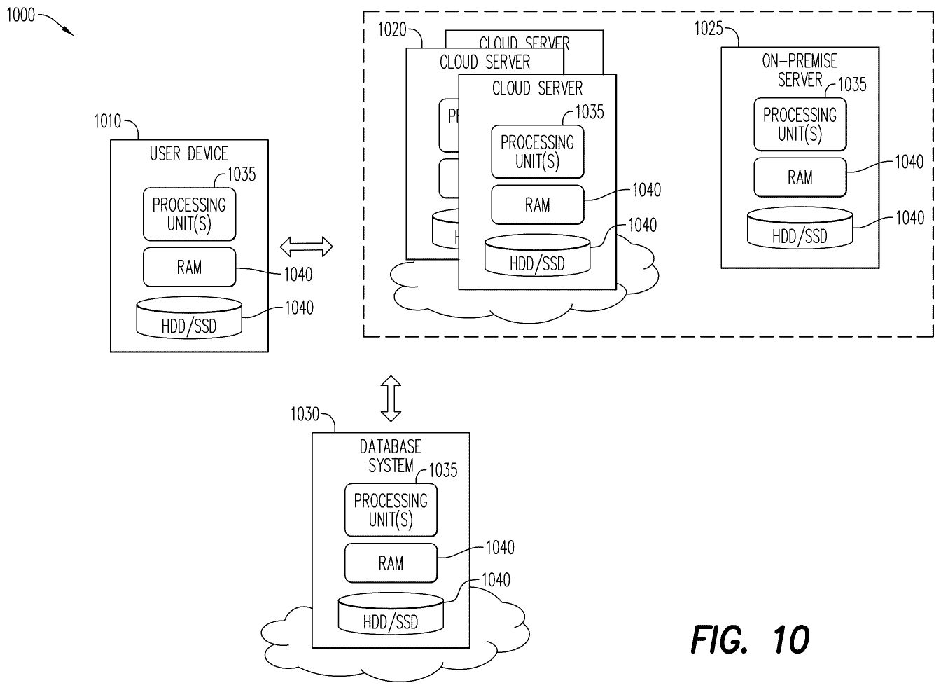

FIG. 2 illustrates a process 200 for generating a template 126 in accordance with an example embodiment. The process 200, and other processes described herein, may be performed by a database node, a cloud platform, a server, a computing system (user device), a combination of devices/nodes, or the like, according to some embodiments. In one or more embodiments, the system architecture 100 may be conditioned to perform the process 200, and other processes described herein, such that a processing unit 1035 (FIG. 10) of the system architecture 100 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Prior to execution of the process, each business object 124 is configured and stored in the database 110. As described above, the configuration may include the properties 132 that may be applicable for each business object. In some embodiments, these properties 132 may be the default properties for the business object and may define the business object unless otherwise deselected. Also prior to execution of the process 200, a user (e.g., template author) has accessed the template tool 104 via a user interface and selected a particular business object from a list of onboarded (e.g., configured and stored) business objects. The list of onboarded business objects may be filtered and/or searched to provide a more targeted list of business objects available for templatization. The targeted list is helpful as there may be tens of thousands of business objects available for selection. As a non-exhaustive example, one of the filtered/and or searched aspects may be for a selected instance or version of the business object. Instances of BOs are defined by the values of their key properties. A key property is used for the unique identification of an object. This is achieved with a key that consists of all the key properties of the object, defined for the object during configuration thereof. Different versions of a business object may exist, where the different versions have the same key properties and one or more different non-key properties.

The target system where the template will be deployed to create the test data may also be selected prior to execution of the process 200.

It is noted that while the description herein is for selection of a single business object to create a template, create test data and/or deploy the test data to a target system at a time, multiple business objects/instances/versions may be selected at a same time such that multi-template creation, multi-template-editing, and multi-deployment are provided by one or more embodiments.

Initially, at S210, information is retrieved for the first business object. The retrieved information may include all of the properties available for the BO 124. The retrieved properties include all of the properties defined for the BO 124 during configuration of the BO 124. Then, at S212, a template definition 134 of the BO is received. The template definition 134 of the BO includes the properties included in the template for the given BO and values for those properties.

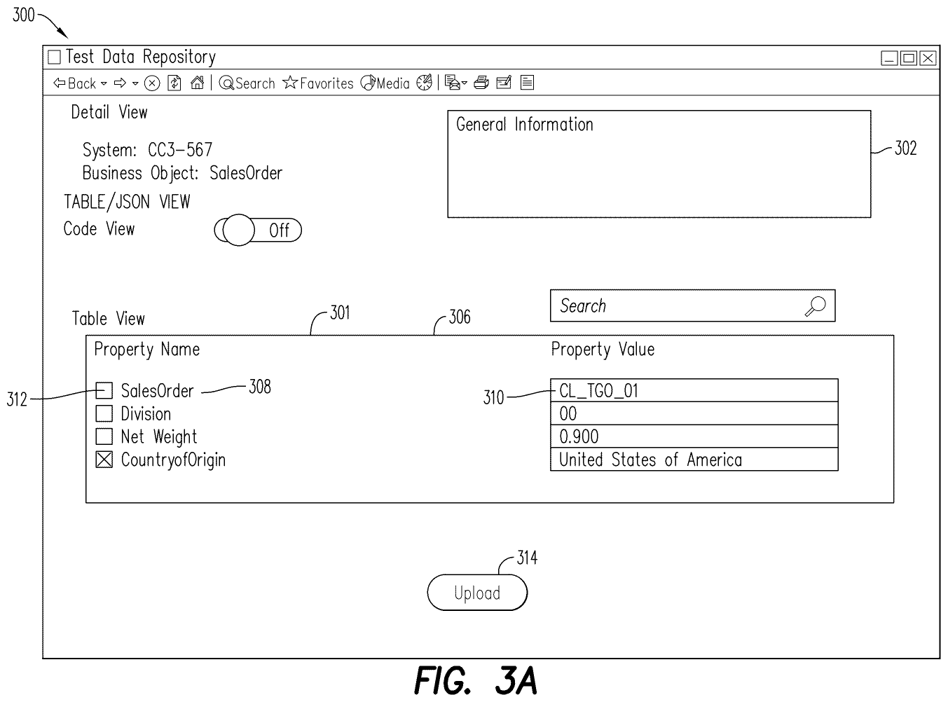

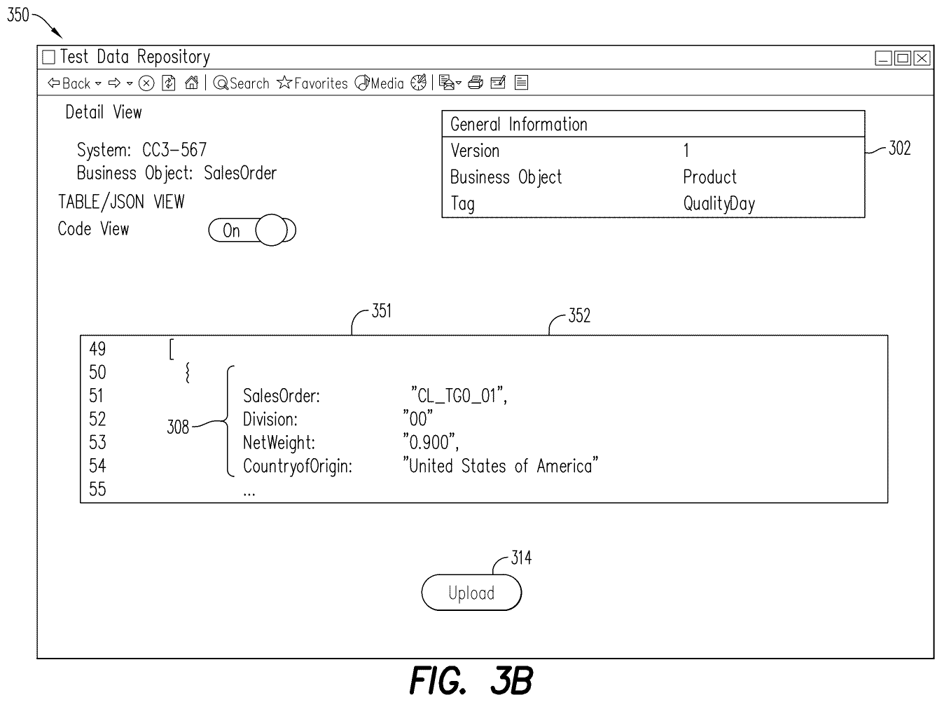

The property information retrieved at S210 may be rendered on a user interface 300 and 350 as shown in FIGS. 3A and 3B, respectively. The property information may be rendered as a table 301 (FIG. 3A) or in a JSON (code) view 351 (FIG. 3B). It is noted that while the JSON view is shown herein, any other suitable machine-readable code may be used. The template author may toggle between the user interface 300 of FIG. 3A and the user interface 350 of FIG. 3B via selection of the toggle icon 303. The same information is provided in both views, with the table view directed to a less technical person. The user interface 300 of FIG. 3A includes a general information section 302. The user interface 300 of FIG. 3A also includes a property section 306 including one or more properties 308 defined for the business object during configuration. In the user interface 350 of FIG. 3B, the properties 308 rendered in the JSON view 351 are listed in the code window 352. In both FIGS. 3A and 3B, the values 310 for these properties may be received to define the template. As shown herein, the business object “SalesOrder” includes properties 308 “SalesOrder”, “Division”, “NetWeight”, and “CountryofOrigin”. Each of these properties 308 has value 310 input by the template author. Herein, the values are “CL_TGO_01; 00; 0.900; and United States of America”, respectively.

The template definition 134 may also include the deselection of one or more properties defined for the BO during configuration of the BO. Deselection may be via selection of an element 312 (e.g., check-box, drop down menu item, radio button, etc.) on the user interface 300 table 301 (FIG. 3A) or via any other selection process. With respect to the user interface 350 JSON view 351 of FIG. 3B, deselection may include deletion of the property. In FIG. 3A, the configuration of the BO included Net Weight, which has been deselected (the check-box is marked) by the template author.

Turning back to the process 200, at S214 a template candidate 156 is transmitted to the data governance tool 152. The template candidate 156 includes the template definition but is only a candidate until approved. The transmission may be in response to selection of an “Upload” icon 314 (FIGS. 3A/3B) on the user interface. As described above, the template candidate 156 is only uploaded to the database 110 after approval via the data governance tool 152.

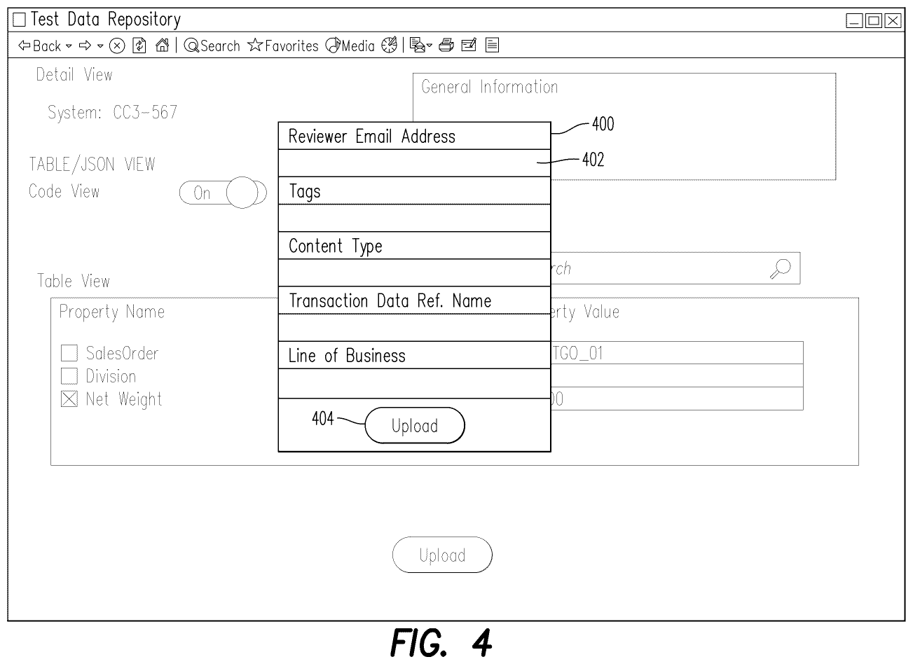

Pursuant to embodiments, after template definition and selection of the “Upload” icon 314, a window 400 (FIG. 4) may be rendered including fields 402 to receive a Reviewer Email Address, and one or more of: Tags, Content Type, Transaction Data Reference Name and Line of Business. The fields 402 may be user-entry fields or may include drop-down lists. The Reviewer Email Address field may receive the reviewer email address(es) of the entity reviewing the template candidate. It is noted that the entity reviewing the template candidate may be an individual, a group, or another application that automatically reviews the template candidate. The “tag” is a term that allows different templates to be linked together based on a common tag. As a non-exhaustive example, a sales order for clothes, a sales order for shoes and a sales order for computers may be linked together by the tag “Sales Order”. As another non-exhaustive example, a department may need particular templates to generate test data at a same or substantially same time for an application, and these templates may then be called together by the common tag for execution thereof. The Tag field 402 provides for a tag to be linked to the template candidate. The Content Type field describes the type of data in the template candidate. The Line of Business (LOB) field describes the specific enterprise area. The selected LOB may determine particular available processes and or functions as the LOB is a logical structural unit or grouping for a specific enterprise area. Selection of the “Upload” icon 404 results in the transmission of the template candidate 156 to the received reviewer email address.

At S216 the data governance tool 152 is executed and it is determined whether the template candidate is approved or rejected. Pursuant to embodiments, execution of the data governance tool 152 includes initiation of the deployment tool 154. The deployment tool 154 simulates execution of the template candidate in the selected system. Using the parameters for the selected system, the deployment tool 154 executes a program that consumes the template candidate to generate simulated test data. During deployment of the template (as opposed to the template candidate), the template author may select a value for the amount of test data generated by the deployment tool (e.g., ten test data samples, one hundred test data samples, etc.), whereas during deployment of the template candidate during simulation, a predefined count/amount of test data is generated. The deployment tool 154 then transmits the output (test data) of the deployment tool 154 back to the data governance tool 152. The data governance tool 152 compares the generated test data to target test data. In a case the generated test data matches the target test data within a pre-set threshold, the template candidate is approved. In a case the generated test data does not match the target test data within the pre-set threshold, the template candidate is rejected. As a non-exhaustive example, the pre-set threshold is related to at least one of: the amount of created test data (e.g., the template candidate is rejected in a case less than the predefined count of test data is created), and the quality of created test data (e.g., the template candidate is rejected in a case a predefined amount of values in the defined properties are missing and/or inaccurate).

In the case the template candidate 156 is rejected, the governance tool 152 transmits a rejection notification to the template author at S218. In some embodiments, the rejection notification may include a reason for the rejection. In the case the template candidate is rejected, the template candidate 156 is not stored in the database. The template author may then edit the template candidate and re-submit the template candidate to the data governance tool 152 at S216 for execution thereof.

In the case the template candidate 156 is approved, the governance tool 152 transmits an approved notification to the template author at S220. Then at S222, the template candidate 156 is saved as a template 126 in the database 110. For an initial template, the template may be stored as version one.

After the template 126 is saved in the database 110, the template 126 may be executed to create non-simulated test data for the target system 114 in S224 via the deployment tool 154. It is noted that the template executed in S224 may be the template just saved to the database 110 in S222 or may be a different template that was previously saved.

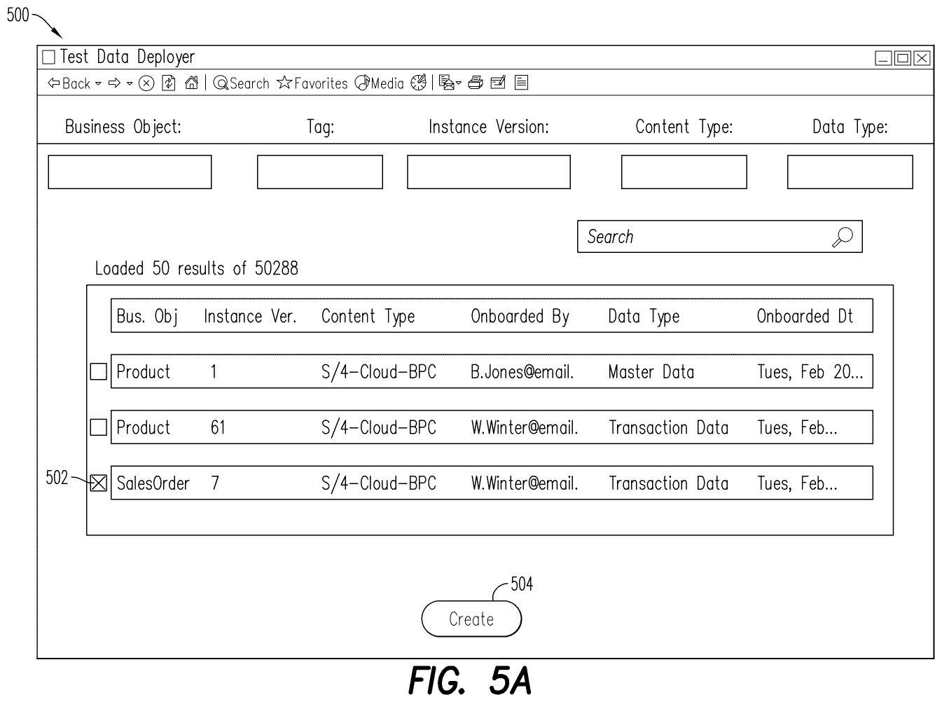

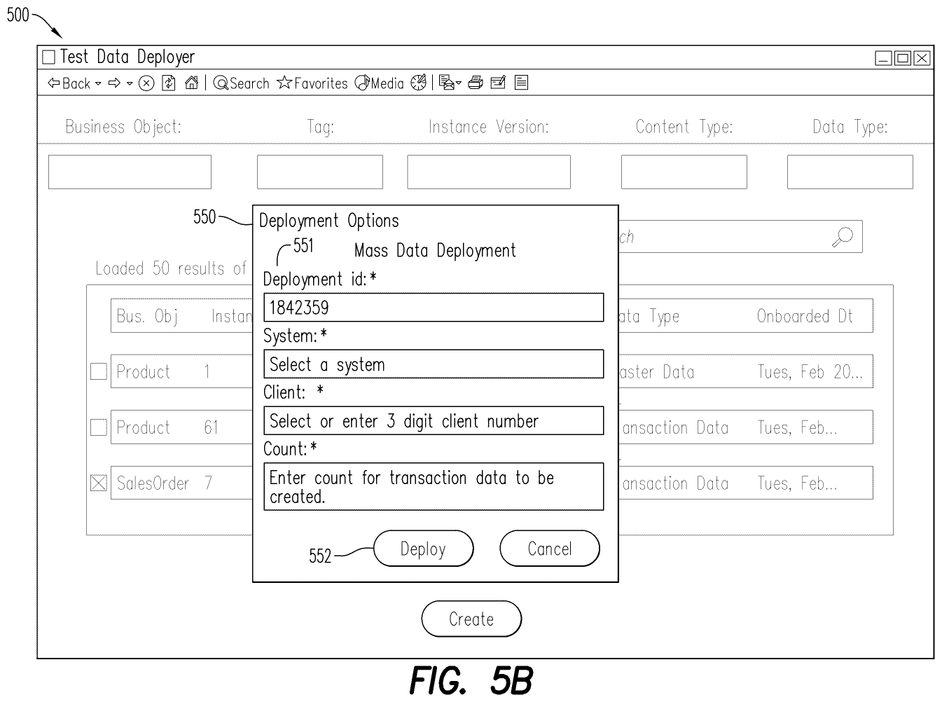

Execution of the template in S224 may include selection of the template from a user interface via a selection of a business object, as shown in the non-exhaustive user interface 500 example provided in FIG. 5A. Here, selection of the business object/template is via check box 502. Other suitable selections may be used. The user may select the “Create” icon 504 to initiate creation of the test data. Selection of the “create” icon 504 results in the Deployment pop-up window 550 shown in FIG. 5B. In the non-exhaustive example shown in FIG. 5B, the Deployment pop-up window 550 includes mandatory fields 551: Deployment id, which may be populated by the system; System, which represents the target system and may be selectable from a drop-down list or other suitable selection process; Client, which identifies the client the data will be created for; and Count, which indicates the number of test data samples to be created. Selection of the “Deploy” icon 552 results in the generation of the test data and deployment/transmission of the generated test data to the target system in S226, as described further below. Advantageously, the same template can be used to create test data for different target systems, as compared to conventional systems where the program created to generate the test data was application-specific. Having an application agnostic template provides for at least reduced storage as a program is not required for each creation of test data per application.

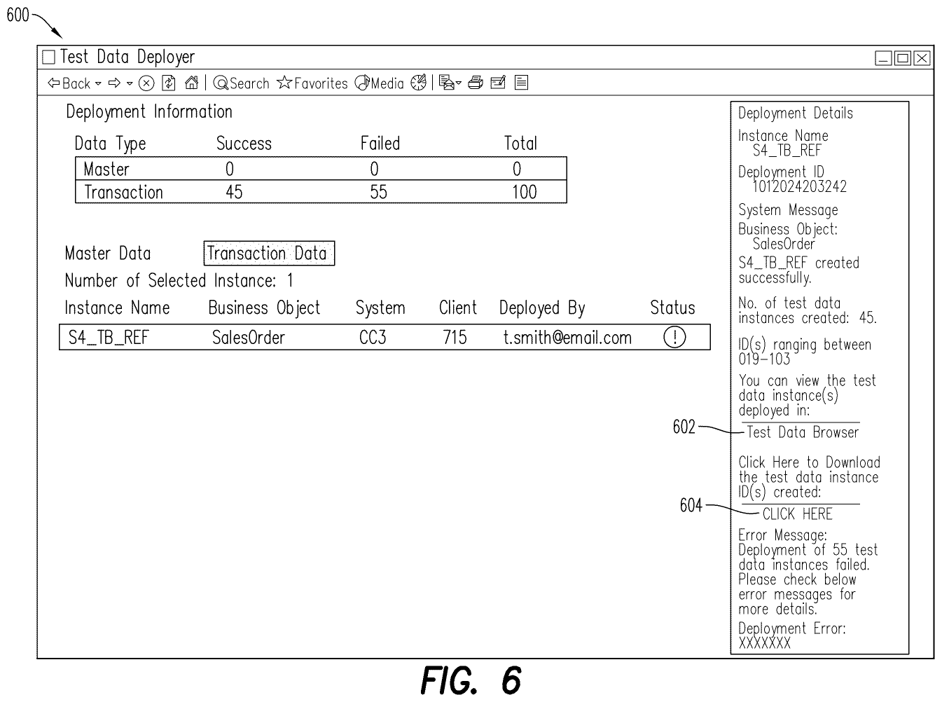

Pursuant to some embodiments, the user may be notified of the deployment status while the test data is being created. As a non-exhaustive example, a pop-up window with percentage complete may be provided. Additionally, in embodiments, after the test data is created, the user may be provided with a test data summary user interface 600 as shown in FIG. 6. As shown in this non-exhaustive example, out of the 100 test data instances requested per the Count mandatory field, 45 were created successfully and 55 were unsuccessful. Each of the test data instances and the test data instance ids are viewable via selection of a respective link 602, 604. Each test data instance includes different data, all based on the same template (e.g., one or more the values for the properties change for each test data instance). As a non-exhaustive example, for one SalesOrder template, multiple copies are created with different data e.g., one test data instance has shoes supplied from warehouse A, while a second test data instance has shoes supplied from warehouse B, while a third test data instance has shoes supplied from warehouse A and being sold to Bill and the first and second test data instances don't list a “sold to” recipient. The deployment tool 154 then deploys the successfully created test data to the target system in S226. The deployment of the created test data 122 to the target system 114 may be in response to the creation of the test data 122 or other suitable target system deployment procedure. In some embodiments, the deployment of the test data to the target system may also be canceled via a suitable cancellation procedure.

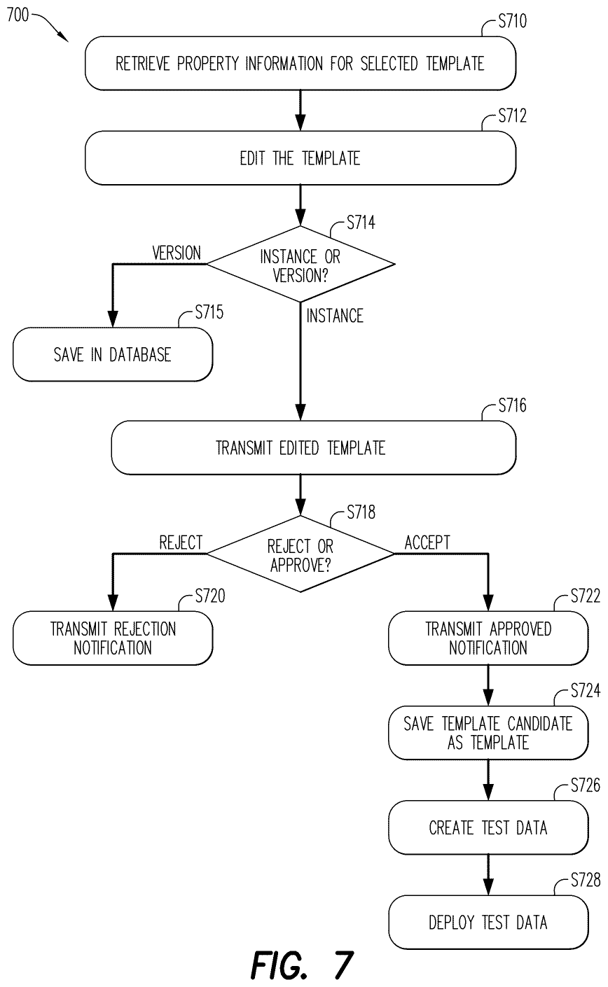

After the template is saved in the database, the template 126 may also be edited. FIG. 7 illustrates a process 700 for editing a template 126 in accordance with an example embodiment.

Prior to execution of the process 700, a user (e.g., template author) has accessed the template tool 104 via a user interface and selected a template from a list of stored templates.

Initially, at S710, information for the template 126 is retrieved. The retrieved information may include the properties selected for the template per the template definition.

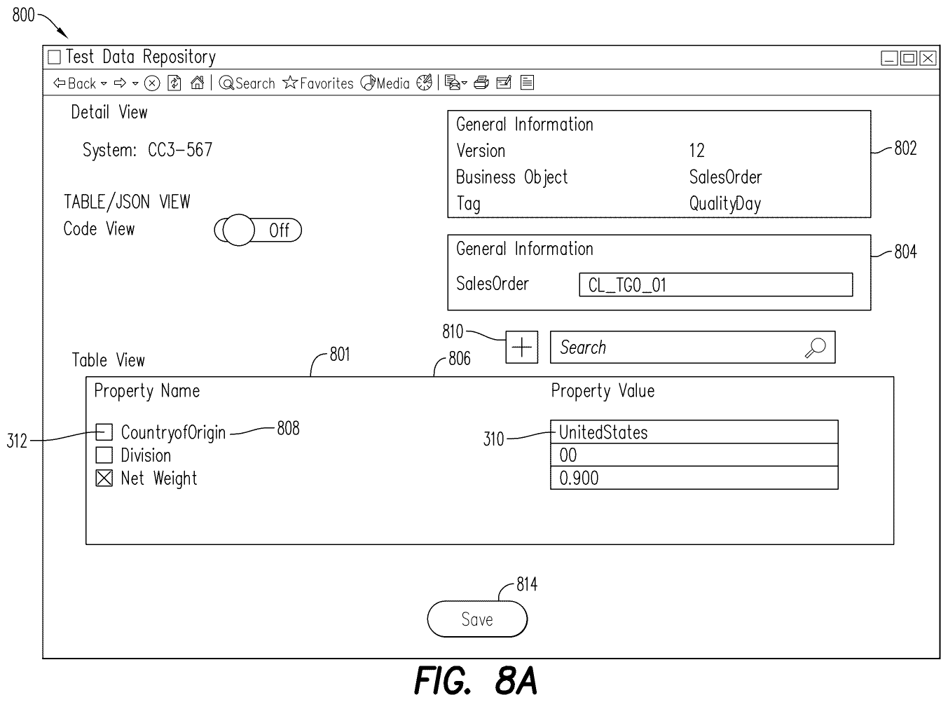

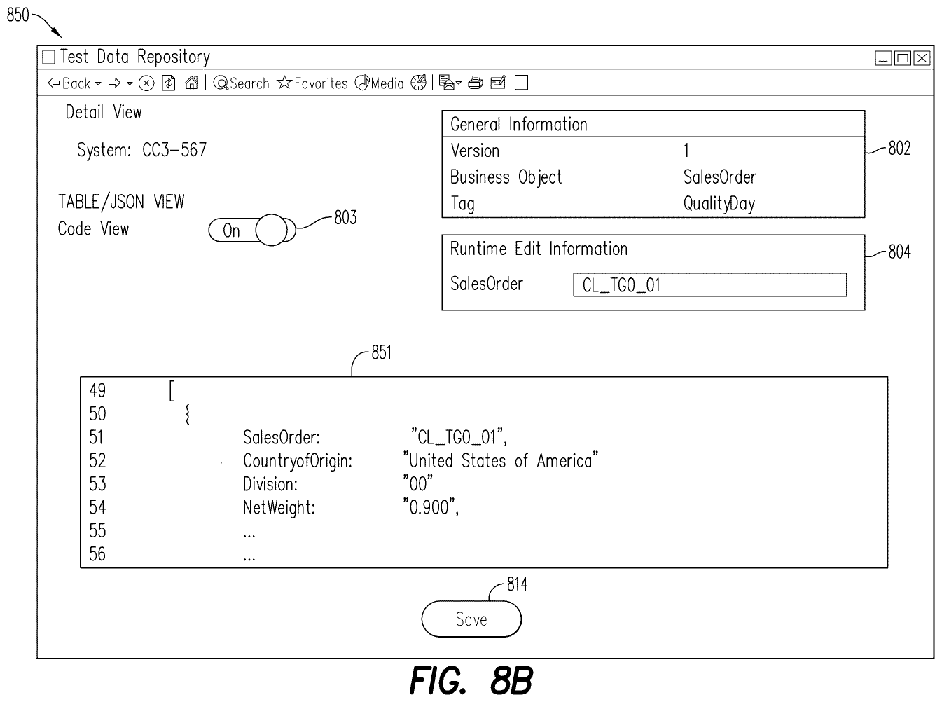

The property information retrieved at S710 may be rendered on a user interface 800 and 850 as shown in FIGS. 8A and 8B respectively. The template author may toggle between the user interface 800 of FIG. 8A and the user interface 850 of FIG. 8B via selection of the toggle icon 803. The same information is provided in both views, with the table view directed to a less technical person. The user interface 800 of FIG. 8A shows the rendering of the property information as table 801. The user interface 850 of FIG. 8B shows the rendering of the property information as a JSON (code) view 851.

The user interface 800 of FIG. 8A includes a general information section 802 and a runtime edit section 804.

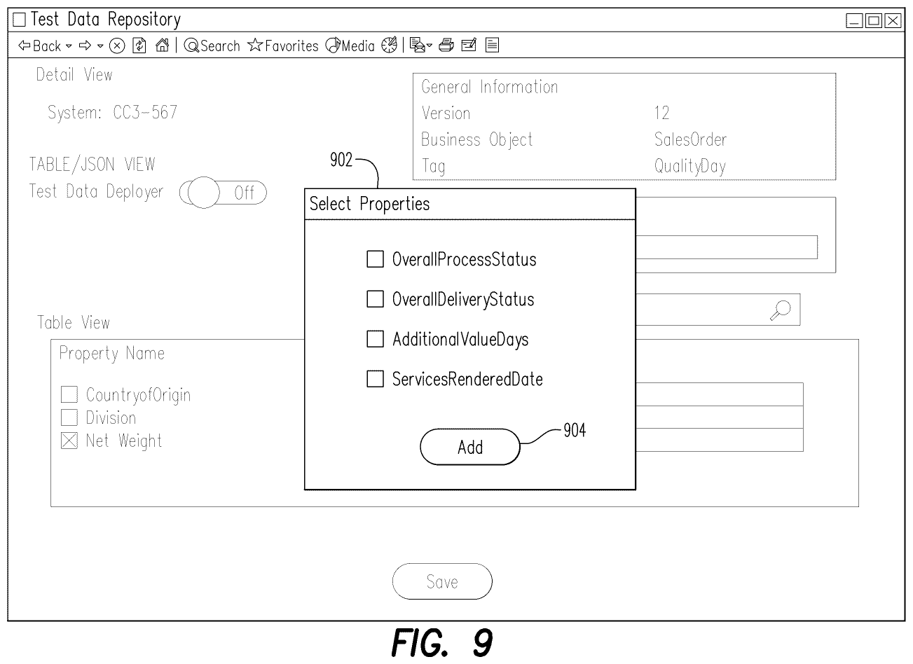

The general information section 802 includes the version number, business object and tag. Other suitable information may be included. It is noted that when the template is created (e.g., saved in the database), there are some properties for the business object that are runtime properties that cannot be edited. These properties may be displayed in the runtime edit section 804. Runtime properties may be assigned by the system. Non-exhaustive examples of runtime properties are a sales order number and a time stamp. The user interface 800 of FIG. 8A also includes a property section 806 including one or more properties 808 defined for the template. Next, in S712, the template is edited. As described above with respect to creating the original template, in editing the template the template author may also deselect/remove properties. In the case of editing, the template author may also add properties. The properties available for inclusion/adding are only those properties included with the definition of the BO at configuration. Pursuant to some embodiments, to add a property, an “add” icon 810 is selected. Other suitable icons may be selected. In response to selection of the “add” icon 810, the template tool 104 retrieves all of the properties defined for the business object during the configuration of that business object. The retrieved properties may be rendered in a pop-up window 902 (FIG. 9). Pursuant to some embodiments, the already included properties are listed and the selection box may be populated with a check. Pursuant to other embodiments (e.g., the embodiment shown in FIG. 9), the already included properties are not included in the pop-up window 902. The retrieved properties may be selected via check-box, as shown herein, or via any other selection process (e.g. radio buttons, text, highlight, etc.). The selected properties may be added via selection of an “Add” icon 904 or other suitable icon. After selection of the properties, values may be assigned thereto. It is further noted that editing the selected template with respect to adding/deselecting/removing properties (e.g., editing affecting the presence or absence of a property) results in a different version of the template, while editing the selected template with respect to changing the values for the properties results in a different instance of the template. At S714 it is determined whether the changes result in a new instance or new version. In some embodiments, the template generation tool 150 makes the determination via comparison to a previously stored version. In other embodiments, a user may designate the changes as being a new version or a new instance via a pop-up window (now shown), for example. With the template edits to properties (e.g., version), the template is again a template candidate 156. In a case the editing results in a different version, the template with the new instance may be saved to the database without being first transmitted to the data governance tool 152 in S715.

In a case the edits result in a different instance, the template candidate with the edited template definition is transmitted to the data governance tool 152 in S716. The transmission may be in response to selection of an “Save” icon 814 (FIG. 8A) on the user interface. Selection of the “Save” icon 814 also saves the changes such that they are reflected in the template candidate stored in the database. With this process 700, after template editing and selection of the “Save” icon, a window may be rendered including fields to receive a Reviewer Email Address, and one or more of: Tag, Content Type, Transaction Data Reference Name and Line of Business. Selection of the “Save” icon on the window results in the transmission of the template candidate 156 to the received reviewer email address.

At S718, the data governance tool 152 is executed, as described above with respect to S216 including initiation of the deployment tool 154, and it is determined whether the template candidate is approved or rejected.

In the case the template candidate 156 is rejected, the governance tool 152 transmits a rejection notification to the template author at S720. In some embodiments, the rejection notification may include a reason for the rejection. In the case the template candidate is rejected, the template candidate 156 is not stored in the database. The template author may then edit the template candidate and re-submit the template candidate to the data governance tool 152.

In the case the template candidate 156 is approved, the governance tool 152 transmits an approved notification to the template author at S722. Then at S724, the template candidate 156 is saved as a template 126 in the database 110. Since this is an edited template, the template may be stored with an appropriate version number greater than “n”, in a case “n” represents version one.

After the template is saved in the database, the template 126 may be executed to create non-simulated test data for the target system in S726 via the deployment tool 154. Execution of the template in S726 may include selection of the template from a user interface, as shown above in the non-exhaustive user interface 500 example provided in FIGS. 5A and 5B. The deployment tool 154 then deploys the created test data to the target system in S728.

FIG. 10 illustrates a cloud-based database deployment 1000 according to some embodiments. The illustrated components may reside in one or more public clouds providing self-service and immediate provisioning, autoscaling, security, compliance and identity management features.

User device 1010 may interact with applications executing on one of the cloud application server 1020 or the on-premise application server 1025, for example via a Web Browser executing on user device 1010, in order to create, read, update and delete data managed by database system 1030. Database system 1030 may store data as described herein and may execute processes as described herein to cause the execution of the template tool 104 for use with the user device 1010. Cloud application server 1020 and database system 1030 may comprise cloud-based compute resources, such as virtual machines, allocated by a public cloud provider. As such, cloud application server 1020 and database system 1030 may be subjected to demand-based resource elasticity. Each of the user device 1010, cloud server 1020, on-premise application server 1025, and database system 1030 may include a processing unit 1035 that may include one or more processing devices each including one or more processing cores. In some examples, the processing unit 1035 is a multicore processor or a plurality of multicore processors. Also, the processing unit 1035 may be fixed or it may be reconfigurable. The processing unit 1035 may control the components of any of the user device 1010, cloud server 1020, on-premise application server 1025, and database system 1030. The storage devices 1040 may not be limited to a particular storage device and may include any known memory device such as RAM, ROM, hard disk, and the like, and may or may not be included within a database system, a cloud environment, a web server or the like. The storage device 1040 may store software modules or other instructions/executable code which can be executed by the processing unit 1035 to perform the method shown in FIGS. 2/7. According to various embodiments, the storage device 1040 may include a data store having a plurality of tables, records, partitions and sub-partitions. The storage device 1040 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM), random-access memory (RAM), and/or any other non-transitory transmitting and/or receiving medium such as the Internet, cloud storage, the Internet of Things (IoT), or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A system comprising:
an object data store storing object data for each object, the object data including one or more properties;
a template data store storing one or more templates associated with the object data;
a memory storing processor-executable program code; and
a processing unit to execute the processor-executable program code to cause the system to:
retrieve information from the object data store for a first object, including available properties for the first object;
define the first object with at least one retrieved available property, the defined first object is a template candidate;
generate simulated test data with the template candidate; and
store the template candidate as a template in the template data store.

2. The system of claim 1, further comprising processor-executable program code to cause the system to:
receive selection of a first template; and
create non-simulated test data based on the selected template.

3. The system of claim 2, wherein the creation of the non-simulated test data further comprises processor-executable program code to cause the system to:
deploy the created non-simulated test data in a target system.

4. The system of claim 3, wherein the target system is selected from a plurality of target systems.

5. The system of claim 1, wherein the template is in a machine-readable format.

6. The system of claim 2, further comprising processor-executable program code to cause the system to:
create a predefined count of the non-simulated test data.

7. The system of claim 6, further comprising processor-executable program code to cause the system to:
generate a rejection notification in a case less than the predefined count of the non-simulated test data is created.

8. The system of claim 1, further comprising processor-executable program code to cause the system to:
automatically transmit the template candidate to a governance tool.

9. The system of claim 2, further comprising processor-executable program code to cause the system to:
receive, prior to creation of the non-simulated test data, one or more changes to the selected first template;
store the changed selected first template as a new version; and
wherein the non-simulated test data is created based on the new version.

10. The system of claim 9, wherein the change is at least one of an inclusion and a removal of one or more properties included in the template.

11. The system of claim 10, wherein the properties are available for change based on one or more properties associated with the object.

12. The system of claim 2, further comprising processor-executable program code to cause the system to:
receive selection of a first instance of the template;
retrieve available properties for the selected first instance;
edit one or more values for the selected first instance; and
store the edited first instance as a second instance.

13. The system of claim 2, further comprising processor-executable program code to cause the system to:
receive selection of a first version of the template;
retrieve available properties for the selected first version;
edit the properties for the selected first version; and
store the edited first version as a second version.

14. A computer-implemented method comprising:
retrieving information from an object data store for a first object, including available properties for the first object;
defining the first object with at least one retrieved available property, the defined first object is a template candidate;
generating simulated test data with the template candidate;
storing the template candidate in the template data store; and
creating non-simulated test data based on the stored template candidate.

15. The method of claim 14, further comprising:
deploying the created non-simulated in a target system.

16. The method of claim 14, further comprising:
receiving, prior to creation of the non-simulated test data, one or more changes to the stored template;
storing the changed template as a new version; and
wherein the non-simulated test data is created based on the changed template.

17. The method of claim 16, wherein the change is of one or more properties included in the template, wherein the properties are available for change based on one or more properties associated with the object during a configuration of the object.

18. One or more non-transitory, computer-readable medium storing instructions, that, when executed by a computing system, cause the computing system to perform operations comprising:
retrieving information from an object data store for a first object, including available properties for the first object;
defining the first object with at least one retrieved available property, the defined first object is a template candidate;
generating simulated test data with the template candidate;
storing the template candidate in the template data store; and
creating non-simulated test data based on the stored template candidate.

19. The medium of claim 18, further comprising:
receiving, prior to creation of the non-simulated test data, one or more changes to the stored template candidate;
storing the changed template candidate as a new instance in a case the change is to a value for at least one available property; and
wherein the non-simulated test data is created based on the new instance.

20. The medium of claim 18, further comprising:
receiving, prior to creation of the non-simulated test data, one or more changes to the stored template candidate;
storing the changed template candidate as a new version in a case the change is to at least one of: a presence and an absence of at least one property included in the template.
